(19) United States
(12) Patent Application Publication
(10) Pub. No.: US 2010/0126003 A1
(43) Pub. Date: May 27, 2010

(54) DEVICE FOR QUICKLY REPLACING A WORK ROLL

(75) Inventors: Giorgio Caprioli, Varese (IT); Dario Marconi, Milano (IT)

Correspondence Address: HOLLAND & HART LLP, 60 E. South Temple, Suite 2000, P.O. Box 11583, Salt Lake City, UT, 84110, US

(73) Assignee: IMEAS S.P.A., Milano (IT)

(21) Appl. No.: 12/622,628

(22) Filed: Nov. 20, 2009

(30) Foreign Application Priority Data
Nov. 21, 2008 (IT) MI2008U000384

(51) Int. Cl. B23P 19/00

(52) U.S. Cl. 29/700

(57) ABSTRACT

A device for quickly replacing a work roll of a machine tool for the surface processing of plate- or strip-like work pieces. The work roll is journaled on suitable journal bearings and the machine tool is provided with roll carrier arms for attachment to the journal bearings. Each of the roll carrier arms comprises a coupling plate and each of the journal bearings comprises a corresponding coupling block for connection to the coupling plate. The coupling plate is provided with a pair of locking pins and the coupling block is provided with a pair of pinholes, for receiving the pair of locking pins when the coupling plate and the coupling block are in a coupling position. The coupling block is further provided with a pair of locking bolts rotatably mounted internally thereof and capable of being reversibly moved between first and second operative angular position

### TECHNICAL FIELD

The present disclosure generally relates to a device for quickly replacing a work roll.

### BACKGROUND

The present invention generally relates to the technical field of machine tools for the surface processing of plate- or strip-like work pieces by means of work rolls or the like, and is concerned in particular with a device which allows the quick replacement of the work rolls used in such machine tools.

Machine tools of the aforementioned kind ordinarily comprise one or more work rolls which are rotatably mounted on suitable supports fixed to the machine frame. Threaded connectors, or equivalent connecting means, are generally used for fastening the supports to the machine frame. While these connecting means allow the work roll supports to be fixedly and securely connected to the machine frame, they have, however, the drawback of making the replacement of the work rolls rather difficult and time consuming to perform, both because of the number of threaded connectors which must be loosened and removed, and because of the position of the same which in some cases is difficult to reach by the operator.

Inasmuch as the replacement of the work rolls, together with their supports, may be necessary not only for maintenance operations, but also for the purpose of varying the type of processing to perform, it would be desirable to have a device that would allow the work rolls to be replaced faster and easier, in order to reduce the maintenance time, as well as to make the required replacement operations ergonomic and simple for the operator.

Such a device should, furthermore, be configured so as to be also applicable to and usable with previously-built machine tools, with minimal modifications thereto, in order to extend the advantages resulting from the use of the device to existing machine tools as well.

### SUMMARY

It is therefore the task of present invention to provide a device for quickly replacing a work roll of a machine tool for the surface processing of plate- or strip-like work pieces, wherein said work roll is journaled on suitable journal bearings and said machine tool is provided with roll carrier arms for attachment to said journal bearings, wherein said roll carrier arms comprise a coupling plate and said journal bearings comprise a corresponding coupling block for connection to said coupling plate, and wherein, for the detachable connection between said coupling plate and said corresponding coupling block said coupling plate is provided with a pair of locking pins and said coupling block is provided with a pair of pinholes, for receiving said pair of locking pins when said coupling plate and said coupling block are in a coupling position, and said coupling block is further provided with a pair of locking bolts rotatably mounted internally thereof and capable of being reversibly moved between a first operative angular position, wherein said locking pins are free to pass into and out from the corresponding pinholes in said coupling block, and a second operative angular position, wherein by means of a positive interlocking said locking bolts prevent said locking pins to pass out from the corresponding pinholes, when said coupling plate and said coupling block are in said coupling position.

### BRIEF DESCRIPTION OF THE DRAWINGS

The present invention will now be described in more detail by reference to an exemplifying and non-limiting embodiment thereof, illustrated in the accompanying drawings in which:

FIG. 1 is a front elevation view of a work roll of a machine tool for the surface processing of plate- or strip-like work pieces illustrating, in cross-section, the journal bearings of the work roll supported by a pair of roll carrier arms attached to the machine frame;

FIG. 2 is a lateral elevation view of the right end of the work roll and its corresponding journal bearing, shown in the condition where the journal bearing is fastened to the roll carrier arm, and

FIG. 3 is a similar view to FIG. 2, but showing the work roll in the condition where the journal bearing is unfastened from the roll carrier arm.

### DETAILED DESCRIPTION

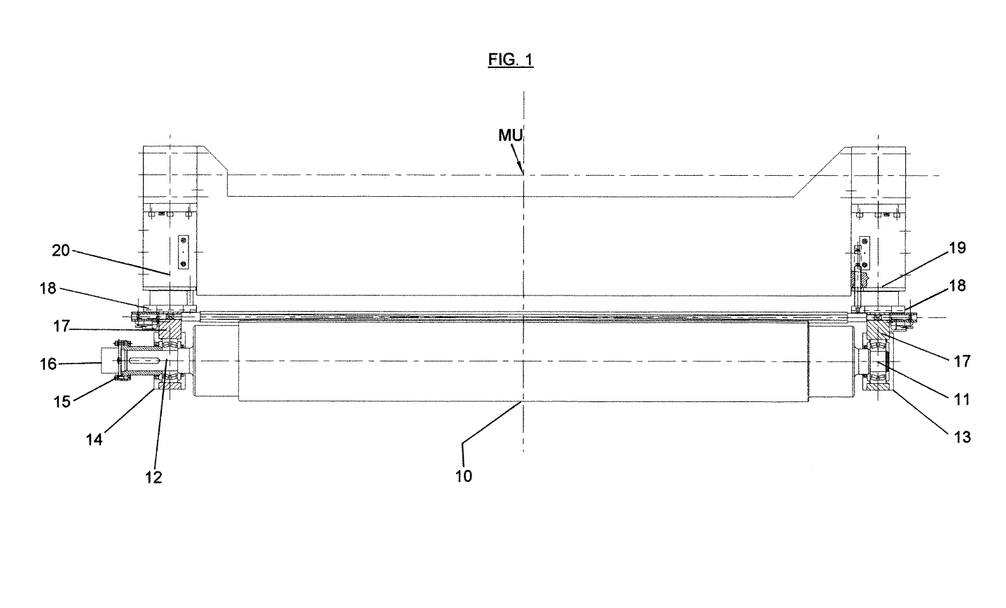

With reference to FIG. 1 of the drawings, there is designated by numeral 10 a cylindrical work roll of a machine tool MU for the surface processing of plate- or strip-like work pieces. The work roll 10 is provided with a pair of end journals, designated by numerals 11 and 12, which are rotatably mounted together therewith on journal bearings 13 and 14, respectively. A joint 15, or a clutch having a quick engaging-disengaging mechanism, connects end journal 12 to a drive shaft 16 which transmits rotary movement to the work roll 10.

Journal bearings 13, 14 are each provided with a coupling block 17 for connection to a corresponding coupling plate 18 of a roll carrier arm 19 and 20, respectively, which is adjustably mounted in the vertical direction on the frame of the machine tool MU.

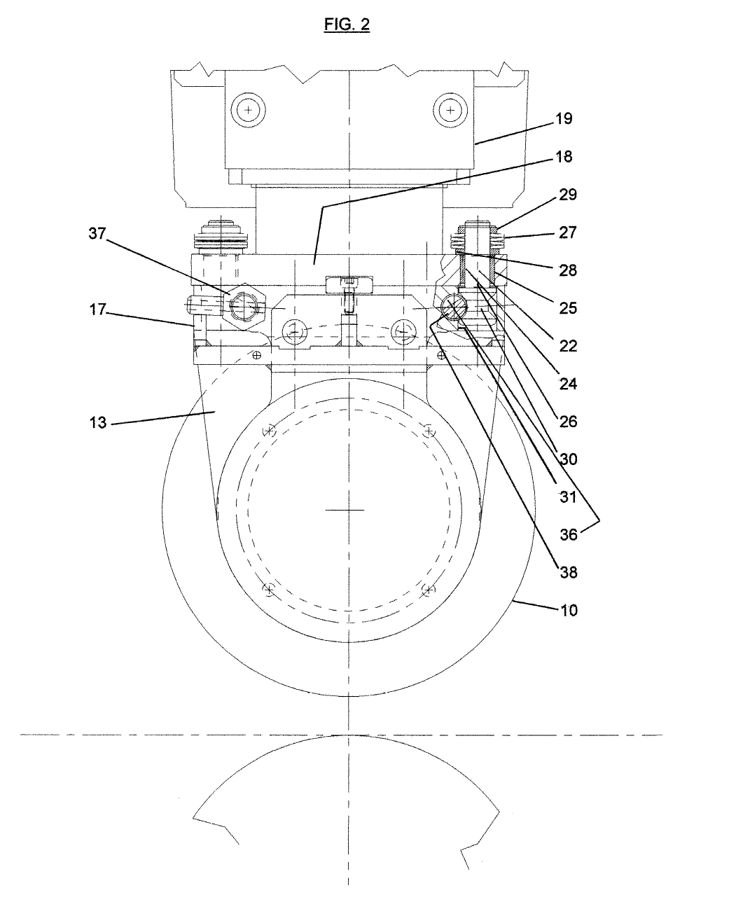

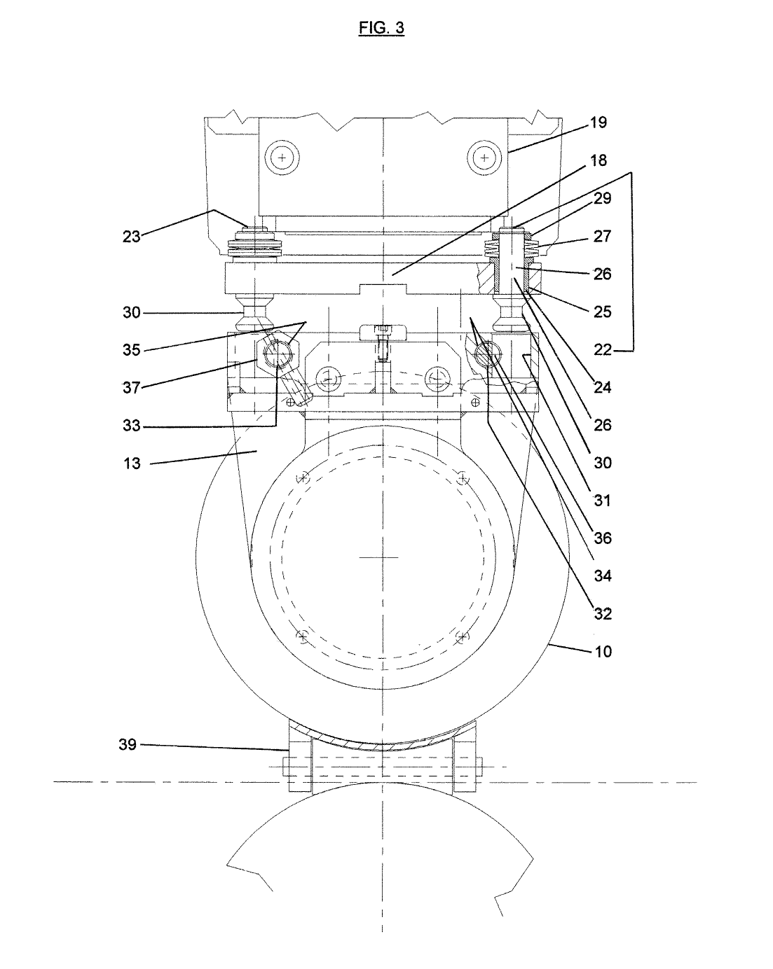

As can be seen particularly in FIGS. 2 and 3 of the drawings, each coupling plate 18 is provided with a pair of locking pins, indicated by numerals 22 and 23, the top and bottom portions of which project therefrom, whereas a central portion of the locking pins 22, 23 is housed in a suitable collared bushing 24 which is firmly arranged in a bore 25 passing through the coupling plate 18.

The top portion of locking pins 22, 23 is formed of a circular cylindrical section 26 which has a thread at its top end. A cupped spring 27 is fitted around the top portion of the locking pins 22, 23 and is pressed against a collar 28 of the bushing 24 by a stop ring 29 which is fastened to the top threaded end of the locking pin 22, 23, so that the pre-load of the spring 27 can be adjusted by operating on the stop ring 29.

The bottom portion of the locking pins 22, 23 projecting from the coupling plates 18 comprises a neck forming section 30, which is preferably trapezoidal in shape and is adapted to be received within corresponding bores 31 made in coupling blocks 17, when the latter and the coupling plates 18 are in a coupling position, as illustrated in FIG. 2 of the drawings.

In order to allow the blocking of the locking pins 22, 23 within the receiving bores 31 there is provided a pair of locking bolts, designated by numerals 32 and 33, which are disposed with their axes parallel one another and perpendicular to the axes of the locking pins 22, 23.

The locking bolts 32, 33 are rotatably guided within bores 34 and 35, respectively, which are made internally of the coupling blocks 17 of the journal bearings 13, 14 and are oriented to intersect a portion of the bores 31 receiving the locking pins 22, 23.

The locking bolts 32, 33 have a shank section which includes a circular semi-cylindrical notch 36 having a radius of curvature which is approximately equal to half the diameter of the receiving bores 31 of the locking pins 22, 23.

An end of the locking bolts 32, 33 projects from one of the coupling blocks 17 and is provided with a bolt head 37 which is shaped so that it can be operated with a suitable tool.

By operating the bolt heads 37, the locking bolts 32, 33 can be rotated between an operative locking position of the locking pins 22, 23, illustrated in FIG. 2 of the drawings, and an operative unlocking position thereof, illustrated in FIG. 3 of the drawings.

Referring particularly to FIG. 3 of the drawings, it will be noted that when the locking bolts 32, 33 are in the operative unlocking position, notch 36 on the locking bolts 32, 33 is disposed facing neck forming section 30 on the locking pins 22, 23 and is flush with the wall of bores 31 receiving the said locking pins. In this operative position of the locking bolts 32, 33, locking pins 22, 23 are free to move into and out of the corresponding receiving bores 31, and thus the coupling plate 18 of the roll carrier arms 19, 20 can be moved close to or away from the corresponding coupling block 17 of the journal bearings 13, 14.

When, instead, the locking bolts 32, 33 are in the operative locking position illustrated in FIG. 2 of the drawings, a convex side 38 thereof, which is located opposite to notch 36, is positively interlocked with the neck forming section 30 of the locking pins 22, 23 and holds the locking pins 22, 23 within the corresponding receiving bores 31, in order to firmly connect the coupling blocks 17 of the journal bearings 13, 14 to the corresponding coupling plates 18 of the roll carrier arms 19, 20. By setting the pre-load of the cupped springs 27 with the stop rings 29, the tightening force between the coupling blocks 17 and the corresponding coupling plates 18 can be adjusted.

In the practise, the operation of the device according to the present invention will be the following. When the replacement of the work roll 10 is required, the machine tool is opened to introduce a carriage 39, or other equivalent means, under the work roll 10, as shown in FIG. 3 of the drawings, for the purpose of supporting the same during its replacement. Thereafter, the bolt heads 37 of the locking bolts 32, 33 are rotated to unlock the locking pins 22, 23 and the roll carrier arms 19, 20 are raised. It is possible at this point to replace the work roll 10 of the machine tool with a new one. Of course, the operations for mounting the new work roll are performed through movements which are opposite to those previously described and sequenced in reverse order.

Advantageously, by virtue of the present invention, the operations for connecting together and disconnecting the coupling block 17 and the coupling plate 18 do not require the fastening and unfastening of bolts, and are performed by simply operating the bolt heads 37, in order to rotate the locking bolts 32, 33 between the operative locking and unlocking positions. The tool for carrying out said operations is conventionally used in the art and is ordinarily provided with the machine tool since it is used for other adjustments thereof.

From the foregoing disclosure it will be understood that the invention solves the problems mentioned in connection with the replacement of the work rolls in surface processing machine tools for plate- or strip-like work pieces. In particular, since the replacement of the work rolls may be frequently required in order to perform different kinds of machining operations, or to change damaged work rolls, the simplicity and quickness of the replacement operations with the device of the invention allows the maintenance time to be drastically reduced and makes the replacement operations required by the operator ergonomic and simple to perform.

What is claimed is:

1. A work roll replacement device, comprising:
a machine tool configured to surface process plate- or strip-like work pieces, the machine tool comprising:
journal bearings arranged to journal a work roll, the journal bearing including:
a coupling block;
a pair of pinholes;
a pair of locking bolts rotatably mounted internally of the journal bearings and capable of being reversibly moved between a first operative angular position and a second operative angular position;
roll carrier arms attached to said journal bearings, said roll carrier arms including:
a coupling plate arranged to connect to said coupling block, said coupling plate being provided with a pair of locking pins insertable into the pair of pinholes when said coupling plate and said coupling block are in a coupling position to provide a detachable connection between said coupling plate and said coupling block, wherein said locking pins are free to pass into and out from their corresponding pinholes in said coupling block when the pair of locking bolts is in the first operative angular position, and wherein by operation of a positive interlocking said locking bolts in the second operative angular position prevent said locking pins to pass out from corresponding pinholes when said coupling plate and said coupling block are in said coupling position.

2. A device according to claim 1, wherein for the positive interlocking between said locking pins and said locking bolts, said locking pins comprise a neck forming section, and said locking bolts are disposed with an axes of each locking bolt arranged parallel one another and perpendicular to the axes of said locking pins, and said locking bolts are rotatably guided at the ends thereof within bores which are made internally of said coupling blocks of the journal bearings and are oriented to intersect a portion of the bores receiving said locking pins.

3. A device according to claim 2, wherein said locking bolts have a shank section comprising a circular semi-cylindrical notch, with a radius of curvature which is approximately equal to half the diameter of the bores receiving said locking pins, and a convex side, located opposite said notch, which is adapted to positively interlock with said neck forming portion of said locking pins and to hold said locking pins within their corresponding receiving bores.

4. A device according to claim 3, wherein said locking bolts have an end projecting from one of said coupling blocks and including a bolt head configured to be operated with a tool, for rotating said locking bolts between an operative locking position, wherein said convex side of said locking bolts faces the neck forming section of said locking pins, and an operative unlocking position, wherein said notch of said locking bolts faces the neck forming section of said locking pins.

5. A device according to claim 1, wherein said work roll carrier arms are connected to the machine tool frame in order to be movable in a vertical direction, for allowing said coupling plate to be moved close to or away from said coupling block.

6. A device according to claim 5, wherein adjustable pre-load resilient means are provided which act upon said locking pins for regulating the tightening force between said coupling plate and said coupling block.
